(19) United States
(12) Patent Application Publication
(10) Pub. No.: US 2014/0068000 A1
(43) Pub. Date: Mar. 6, 2014

(54) SYSTEM AND METHOD FOR RENDERING WEB CONTENT

(71) Applicant: M/s MobileMotion Technologies Private Limited, Bengaluru (IN)

(72) Inventor: Ravi Pratap MADDIMSETTY, Bengaluru (IN)

(73) Assignee: M/s MobileMotion Technologies Private Limited, Bengaluru (IN)

(21) Appl. No.: 14/016,547

(22) Filed: Sep. 3, 2013

Related U.S. Application Data
(60) Provisional application No. 61/696,272, filed on Sep. 3, 2012.

(51) Int. Cl. H04L 29/08

(52) U.S. Cl. CPC H04L 67/02
USPC 709/217

(57) ABSTRACT

The present invention provides a method and a system for rendering web content on a mobile computing device associated with a user over a network. The method and system includes receiving a request for web content from the mobile computing device associated with the user, detecting identification information of the requesting mobile computing device, determining display capabilities of the mobile computing device based on the detected identification information, retrieving the requested web content and a plurality of customization parameters from a content server of a plurality of content severs and customizing the retrieved web content based on the determined display capabilities of the mobile computing device and the customization parameters. The customized web content is rendered on the mobile computing device.

### CROSS-REFERENCE TO RELATED APPLICATIONS

This application claimed priority to Provisional Application Ser. No. 61/696,272 filed Sep. 3, 2012, the contents of which are hereby incorporated by reference.

### FIELD OF THE INVENTION

The present invention relates to methods and systems for displaying web content, and more particularly, relates to methods and systems for displaying customized web content on mobile devices.

### BACKGROUND OF THE INVENTION

The World Wide Web (WWW), also known as the “Web” refers to a system of interlinked hypertext documents accessible over the Internet. This system allows for information to be communicated over any number of interconnected devices, for example, servers, networks, computers, etc. Typically, the information or web content is located at websites that are hosted on one or more web servers. A website is composed of a set of related web pages. A web page refers to a document typically written in plain text and formatted using HyperText Markup Language (HTML) or eXtensible HyperText Markup Language (XHTML). Further, the web page may be embedded with style sheets, scripts, hypertext links to other web pages, images, etc.

The web pages can be accessed by a user via a user agent such as a mobile application, an audio browser, a web browser running on a user device, etc. The user device is, for example, a cell phone, a laptop, a tablet, a smartphone, a personal digital assistant (PDA), a personal computer, etc. Conventionally, the web browser on the user device requests for a web page hosted on one or more web servers using the Hypertext Transfer Protocol (HTTP).

Conventionally, the web content is procured for each request made by a browsing entity, the browsing entity being an application running on a user device. The web content thus procured is customized for different user devices by pre-segmenting the user devices into different categories, for example, iPhone® of Apple Inc, Android phones, Blackberry® phones of Research in Motion Limited, etc. However, the process of procuring the web content each time a request is made is time and resource consuming and therefore inefficient.

Furthermore, conventional methods of serving customized scripting files such as Cascading Style Sheets (CSS) to a user device involves storing multiple versions of the CSS files on a server. This results in inefficiencies in processing webpage requests as the server has to render the customized CSS files multiple times for a webpage request from the same user device. Hence, there is a need to serve customized CSS files to user devices without having to maintain multiple versions of the CSS files on the server.

In light of the above stated discussion, there is a need for a method and a system which will overcome the above stated problems.

### BRIEF DESCRIPTION OF THE INVENTION

The above-mentioned shortcomings, disadvantages and problems are addressed herein which will be understood by reading and understanding the following specification.

In an aspect of the present invention, a method for rendering web content on a mobile computing device, associated with a user over a network is provided. The method includes receiving a request for web content from the mobile computing device associated with the user and detecting identification information of the requesting mobile computing device. Further, the method includes determining display capabilities of the mobile computing device based on the detected identification information and retrieving the requested web content and a plurality of customization parameters from a content server of a plurality of content severs. Furthermore, the method includes customizing the retrieved web content based on the determined display capabilities of the mobile computing device and the customization parameters. Accordingly, the customized web content is rendered on the mobile computing device.

In an embodiment of the present invention, the method further includes checking availability of the requested web content and fetching the requested web content from the content server of the plurality of content servers. The display capability includes at least one of form factor of the mobile computing device, characteristics of the mobile computing device, features of the mobile computing device, attributes of the mobile computing device, browsing entity attributes of the mobile computing device and limitations of the mobile computing device. The form factor of the mobile computing device comprises at least one of physical dimensions of display of the mobile computing device. The characteristics of the mobile computing device include at least one of script execution capabilities and multimedia handling capabilities. The browsing entity attributes of e mobile computing device comprises at least script execution capabilities and multimedia handling capabilities.

In an embodiment of the on the method further includes parsing the acquired web content into separate one or more component parts. The one or more component parts are stored individually for the server of the plurality of content servers.

In an embodiment of the present invention, customizing the separated one or more component parts of the content based on the determined display capability and the customization parameters further includes determining a level of rendering required for presentation of web content on the mobile computing device. The level of rendering required for presentation of web content on mobile computing device is based on the determined display capability of the mobile computing device and the customization parameters.

In another aspect of the present invention, a method for rendering web content on a mobile computing device associated with a user over a network is provided. The method includes receiving a request for web content from the mobile computing device associated with the user, detecting identification information of the requesting mobile computing device and determining display capabilities of the mobile computing device based on the detected identification information. Further, the method includes retrieving the requested web content and a plurality of customization parameters from a content server of a plurality of content severs and customizing the retrieved web content based on the determined display capabilities of the mobile computing device and the //parameters. The retrieving of content includes checking availability of the requested web content and fetching the requested web content from the content server of the plurality of content servers. Accordingly, the customized web content is rendered on the mobile computing device.

In an embodiment, the display ea includes at least one of form factor of the mobile computing device, characteristics of the mobile computing device, features of the mobile computing device, attributes of the mobile computing device, browsing entity attributes of the mobile computing device and limitations of the mobile computing device. The form factor of the mobile computing device comprises at least one of physical dimensions of display of the mobile computing device. The characteritics of the mobile computing device include at least one of script executing capabilities and multimedia handling capabilities. The browsing entity attributes of the mobile computing device comprises at least one of script execution capabilities and multimedia handling capabilities.

In an embodiment of the present invention, the method further includes parsing the acquired web content into separate one or more component parts. The one or more component parts are stored individually for the content server of the plurality of content servers.

In an embodiment of the present invention, customizing the separated one or more component parts of the web content based on the determined display capability and the customization parameters further includes determining a level of rendering required for presentation of web content cm the mobile computing device. The level of rendering required for presentation of web content on the mobile computing device is based on the determined display capability of the mobile computing device and the customization parameters.

In another aspect of the present invention, a computer system for rendering web content on a mobile computing device associated with a user over a network is provided. The computer system includes one or more processors and a non-transitory memory containing instructions that, when executed by the one or more processors, causes the one or more processors to perform a set of steps. The steps include receiving a request for web content from the mobile computing device associated with the user, by a request processing module of a content customization platform of the computer system. Further, the steps include detecting identification information of the requesting mobile computing device by a device detection application of the content customization platform of the computer system. Furthermore, the steps include determining display capabilities of the mobile computing device based on the detected identification information by the device detection application of the content customization platform of the computer system. Moreover, the steps include retrieving the requested web content and a plurality of customization parameters from a content server of a plurality of content severs by a data acquisition module of the content customization platform of the computer system. In addition, the steps include customizing the retrieved web content based on the determined display capabilities of the mobile computing device and the customization parameters. Accordingly, the customized web content is rendered on the mobile computing device.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

For a more complete understanding of example embodiments of the present technology, reference is now made to the following descriptions taken in connection with the accompanying drawings in which:

FIG. 1 illustrates a system for rendering web content on a mobile computing device associated with a user over a network, in accordance with various embodiments of the present invention.

FIG. 2 illustrates a block diagram of a computer system having a content customization platform, in accordance with various embodiments of the present invention;

FIG. 3 illustrates various components of the content customization platform, in accordance with various embodiments of the present invention;

FIG. 4 illustrates a flow chart for rendering web content on the mobile computing device associated with the user over the network, in accordance with an embodiment of the present invention: and

FIG. 5 illustrates a flow chart for rendering web content on the mobile computing device associated with the user over the network, in accordance with another embodiment of the present invention.

### DETAILED DESCRIPTION OF THE INVENTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “embodiment” means that a particular feature, structure, or characteristic described in connection with the embodiment is included in at least one embodiment of the present technology. The appearance of the phrase “in one embodiment” in various places in the specification are not neccessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

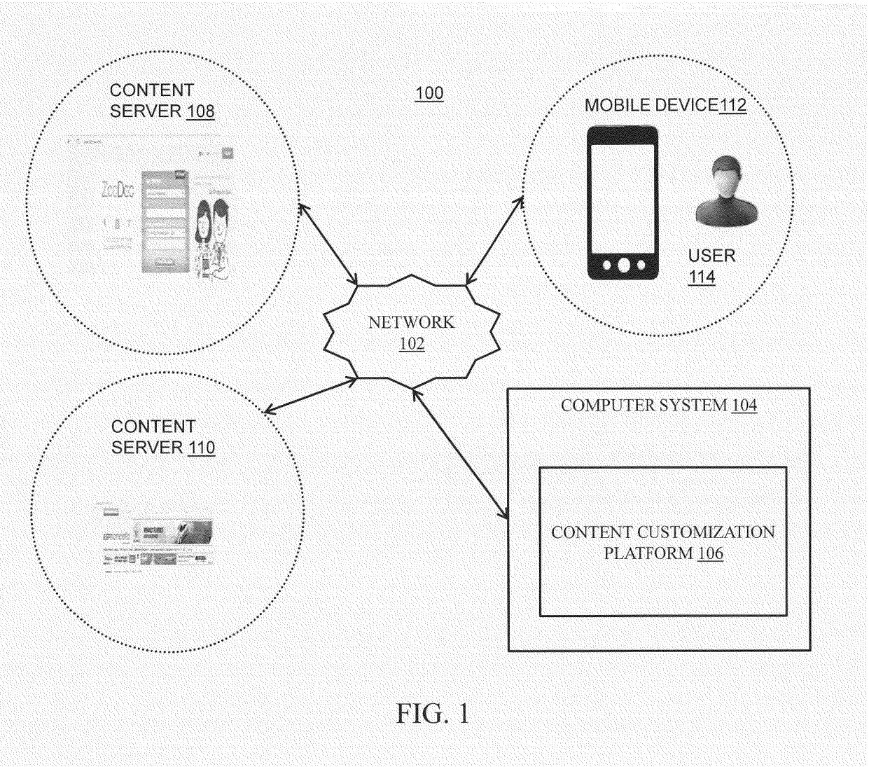

FIG. 1 illustrates a system 100 for rendering web content on a mobile device 112, in accordance with various embodiments of the present invention. The system 100 includes one or more content servers (shown as a content server 108 and a content server 110). In addition, the system 100 includes a user 114 accessing web content of the content server 108 and/or the content server 110 with the mobile device 112 through a network 402. In addition, a computer system 104 having a content customization platform 106 renders the content of the content server 108 and/or the content server 110 through the network 102.

It may be noted that the term ‘web content’ refers to contents of a web page of the content server 108 or a web page of the content server 110. The web page refers to information resource that can be accessed through a web browser and displayed on the mobile device 112. The web page can have different type of information which may include but may not be limited to audio, video, images, and pictures. The look, feel, layout, design, etc., of the web page is provided by cascading style sheet (CSS) instructions. The CSS instructions refer to a language used for describing the presentation semantics of a document written in a markup language. In other words, the elements that contribute to the look and feel of a web page are provided by the CSS instructions.

As used herein, the term the mobile device 112′ refers to a handheld electronic device that can be used to access the web page on the Internet. Examples of the mobile device 112 can include but may not be limited to a cell phone, a smart phone, a personal digital assistant (PDA), a wireless email terminal, a laptop, and a tablet computer.

As used herein, the term ‘the content server 108’ refers to a website that hosts web pages comprising the web content and having an association with the content customization platform 106. Similarly, the term ‘the content server 110’ refers to a website that hosts pages comprising the web content and having an association will the content customization platform 106.

It may be noted that the system 100 is shown to have the content server 108 and the content server 110; however, those skilled in the art would appreciate that the system 100 can include one or more content server. It addition, it may also be noted that for the sake of simplicity, the present invention will be explained by referring to the content server 108; however, those skilled in the art would appreciate that the present invention can be exercised on one or more content servers.

The content server 108 associates with the content customization platform 106 of the computer system 104. For example, the content server 108 registers with the content customization platform 106 to customize the web content according to the mobile device 112. Similarly, the content server 110 (and other one of more content servers) registers with the content customization platform 106 to customize the web content according to the mobile device 112. It may also be noted that the present invention is explained to customize the web content of the content server 108 according to the mobile device 112; however, those skilled in the art would appreciate that web content of the content server 108 is customized according to the different mobile devices associated with different users. In addition, the web content of the content server 110 (and one or more publishers) is customized according to the different mobile devices associated with different users.

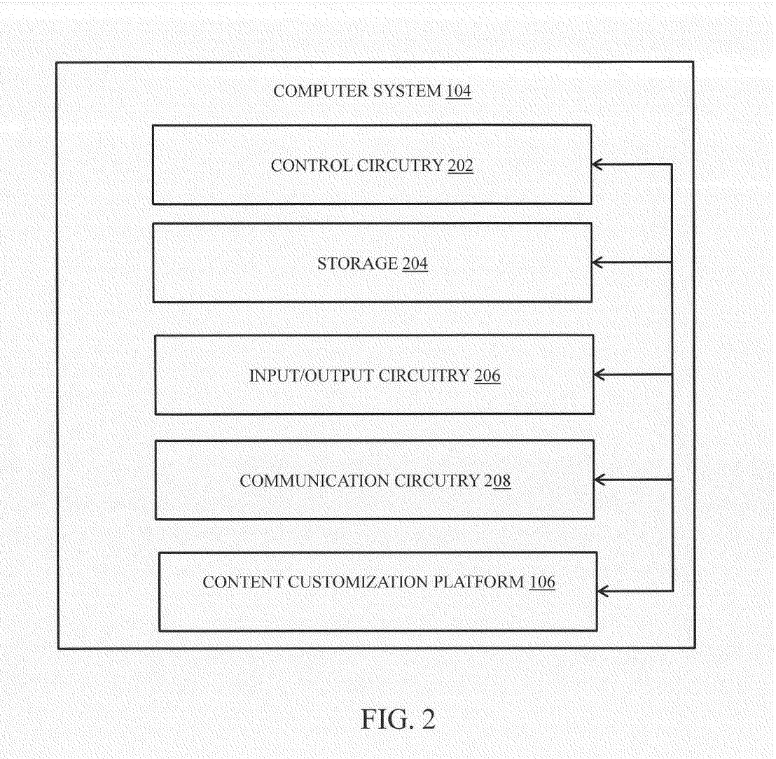

In an embodiment of the present invention, the web content of the content 108 is customized by the content customization platform 106 residing in the computer system 104. As illustrated in the FIG. 2, the computer system 104 includes a control circuitry 202, a storage 204, an input/output (“I/O”) circuitry 206, a communications circuitry 208 and the content customization platform 106.

Those skilled in the art would appreciate that the computer system 104 of FIG. 2 may include one or more components which may not be shown here. These one or more components of the computer system 104 may be combined or omitted with the components shown in FIG. 2. The computer system 104 includes any suitable type of electronic device. Examples of the computer system 104 include but may not be limited to a digital media player (e.g., an iPod™ made available by Apple Inc. of Cupertino. Calif.), a personal e-mail device Blackberry™ made available by Research in Motion of Waterloo, Ontario), a personal data assistant (“PDA”), a cellular telephone, a Smartphone, a handheld gaming device, a digital camera, a laptop computer, and a tablet computer. In another embodiment of the present invention, the computer system 104 can be a desktop computer.

From the perspective of this invention, the control circuitry 202 includes any processing circuitry or processor operative to control the operations and performance of the computer system 104. For example, the control circuitry 202 may be used to run operating system applications, firmware applications, media playback applications, media editing applications, or any other application. In an embodiment, the control circuitry 202 drives a display and process inputs received from a user interface.

From the perspective of this invention, the storage 204 includes one or more storage mediums including a hard-drive, solid state drive, flash memory, permanent memory such as ROM, any other suitable type of storage component, or any combination thereof. The Storage 204 may store, for example, media data (e.g., music and video files), application data (e.g., for implementing functions on the computer system 104).

From the perspective of this invention, the 110 circuitry 206 may be operative to convert (and encode/decode, if necessary) analog signals and other signals into digital data. In an embodiment, the I/O circuitry 206 may also convert digital data into any other type of signal, and vice-versa. For example, the I/O circuitry 206 may receive and convert physical contact inputs (e.g., from a multi-touch screen), physical movements (e.g., from a mouse or sensor), analog audio signals (e.g., from a microphone), or any other input. The digital data may be provided to and received from the control circuitry 202, the storage 204, or any other component of the computer system 104.

It may be noted that the I/O circuitry 206 is illustrated in FIG. 2 as a single component of the computer system 104; however those skilled in the art would appreciate that several instances of the I/O circuitry 206 may be included in the computer system 104.

The computer system 104 may include any suitable interface or component for allowing a user to provide inputs to the I/O circuitry 206. The computer system 104 may include any suitable input mechanism. Examples of the input mechanism include but may not be limited to a button, keypad, dial, a click wheel, and a touch screen. In an embodiment, the computer system 104 may include a capacitive sensing mechanism, or a multi-touch capacitive sensing mechanism.

in an embodiment, the computer system 104 may include specialized output circuitry associated with output devices such for example, one or more audio outputs. The audio output may include one speakers built into the computer system 104 or an audio component may include one or more speakers built into the computer system 104, or an audio component that may be remotely coupled to the computer system 104.

The one or more speakers can be mono speakers, stereo speakers, or a combination of both. The audio component can be a headset, headphones or ear buds that may be coupled to communications device with a wirelessly.

In an embodiment, the I/O circuitry 206 may include display circuitry for providing a display visible to the user. For example, the display circuitry may include a screen (e.g., an LCD screen) that is incorporated in, the computer system 104.

The display may circuitry may include a movable display or a projecting system for providing a display of content on a surface remote from the computer system 104 (e.g., a video projector). In an embodiment, the display circuitry may include a coder/decoder to convert digital media data into analog signals. For example, the display circuitry may include video Codecs, audio Codecs, or any other suitable type of Codec.

The display circuit.; may include display driver circuitry, circuitry for driving display drivers, or both. The display circuitry may be operative to display convent The display content can include media playback information, application screens for applications implemented on the electronic device, information regarding ongoing communications operations, information regarding incoming communications requests, or device operation screens under the direction of the control circuitry 202. Alternatively, the display circuitry may be operative to provide instructions to a remote display.

From the prospective of this invention, the communications circuitry 208 may include any suitable communications circuitry operative to connect to a communications network and to transmit the communications (e.g., voice data) from the computer system 104 to other devices within the communications network. The communications circuitry 208 may be operative to interface with the communications network using any suitable communications protocol. Examples of the communications protocol include but may not be limited to Wi-Fi, Bluetooth.R™, radio frequency systems, infrared, LTE, GSM, GSM plus EDGE, CDMA, and quadband.

In an embodiment, the same instance of the communications circuitry 208 may be operative to provide for communications over several communications networks. In an embodiment, the computer system 104 may be coupled a host device for data transfers, synching the communications device, software or firmware updates, providing performance information to a remote source (e.g., providing riding characteristics to a remote server) or performing any other suitable operation that may require the computer system 104 to be coupled to a host device. Several computing devices may be coupled to a single host device using the host device as a server. Alternatively or additionally, the computer system 104 may be coupled to several host devices (e.g., for each of the plurality of the host devices to serve as a backup for data stored in the computer system 104).

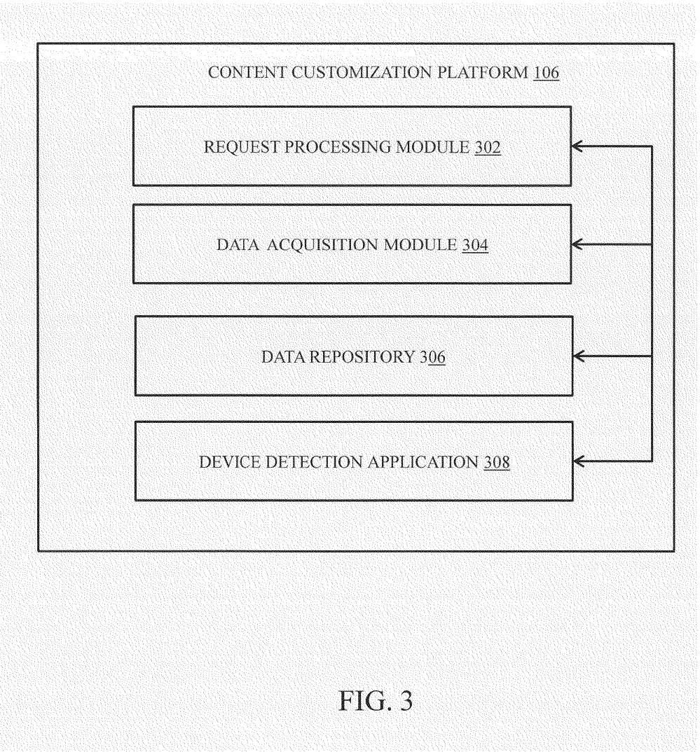

The content customization platform 196 of the computer system 104 enables the customization of the web content in conjunction with the control circuitry 202, the storage 204, the input/output circuitry 206 and the communication circuitry 208. As illustrated in FIG. 3, the content customization platform 106 includes a request processing module 302, a data acquisition module 304, a data repository 306, and a device detection application 308. Those skilled in the art would appreciate that the content customization platform 106 of FIG. 3 may include one or more components which may not be shown here. In addition, it may be noted that references will be made to the system elements of FIG. 1 and FIG. 2 to explain the various components along with their respective components of the content customization platform 106 shown in FIG. 3.

The request processing module 302 receives a request for the web content from the mobile device 112. The device detection application 308 detects identification information of the requesting mobile device 112 and determines display capabilities of the mobile device 112. The data acquisition module 304 retrieves the requested web content and customization parameters from the content server 108 that hosts the requested web content and customizes the retrieved web content. The web content is customized based on the determined display capabilities of the mobile device 112 and the customization parameters. The request processing module 302 provides the customized web content to the requested mobile device 112.

The data acquisition module 304 of the content customization platform 106 is configured to acquire web content from one or more registered content servers 108 and 110, on a periodical basis based on the periodicity specified by the content publisher owning the content server 108 and 110, or the periodicity specified in the SLA (Service Level Agreement). The acquired web content is parsed into separate components such as text, image, audio and video and stored in the data repository 306.

In an embodiment, the user 114 of the mobile device 112 may request for the web content via a browsing entity installed on the mobile device 112. The request processing module 302 checks if the requested content is available in the data repository 306. If the requested content is available in the data repository 306, the requested web content is sourced from one of the content servers 108 and 110 that host the requested web content via the data acquisition module 304. The content customization platform 106 communicates with the content server 108 and the mobile device 112 via the network 102.

In an embodiment, the device detection application 308 acquires display capabilities of a browsing entity requesting the web content from a device database. The device database refers to a database including a list, of all available browsing entities and their corresponding display capabilities. In one embodiment, the device database may be a part of one of the content customization platform 106 and the data repository 306. In another embodiment, the device database is hosted on a cloud or an external server and communicates with the content customization platform 106 via the network 102.

The data acquisition module 304 retrieves the requested web content and customization parameters from the content server 108 that hosts the requested web content. The data acquisition module 304 customizes the retrieved web content based on the determined display capabilities of the mobile device 112 and the customization parameters. Following the customization of the web content, the request processing module 302 renders the customized web content to the requested mobile device 112.

In an embodiment, accordingly, a cookie may be saved on the web browser of the mobile device 112. Moreover, a cached version of one or more customized CSS files fin the particular mobile device 112 mapped onto the cookie of the corresponding mobile device 112 is maintained at the data repository 306. The subsequent requests for the same web content placed from the same mobile device 112, is identified by reading the saved cookie on the web browser of the mobile device 112. Accordingly, the web content is rendered using the cached CSS files previously rendered for the same mobile device 112.

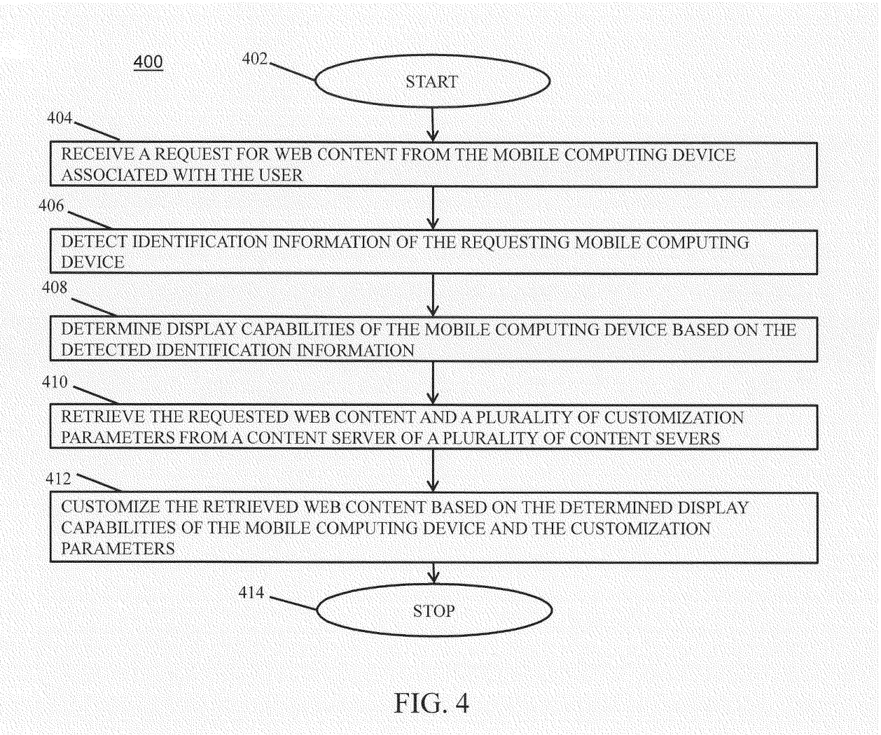

FIG. 4 illustrates a flow chart 400 for rendering web content on the mobile computing device 112 associated with the user 114 over the network 102, in accordance with an embodiment of the present invention. It may be noted that to explain the flow chart 400, references will be made to the system elements of the description of FIG. 1, FIG. 2 and FIG. 3, in addition, those skilled in the art would appreciate that the flow chart 400 may have more or less number of steps which is in the scope of the present invention.

At step 402, the flow chart 400 initiates. At step 404, the content customization platform 106 receives a request for web content from the mobile device 112 associated with the user 114. At step 406, the content customization platform 10$ detects identification information of the requesting mobile computing device 112. At step 408, the content customization platform 106 determines display capabilities of the mobile device 112 based on the detected identification information. At step 410, the content customization platform 106 retrieves the requested web content and a plurality of customization parameters from the content server 108. At step 412, the content customization platform 106 customizes the retrieved web content based on the determined, display capabilities of the mobile device 112 and the customization parameters. Accordingly, the customized web content is rendered on the mobile device 112. In this embodiment of the present invention, the display capability includes at least one of form factor of the mobile device 112, characteristics of the mobile device 112, features of the mobile device 112, attributes of the mobile device 112, browsing entity attributes of the mobile device 112 and limitations of the mobile device 112. The form factor of the mobile device 112 includes at least one of physical dimensions of display of the mobile device 112. The characteristics of the mobile device 112 include at least one of script, execution capabilities and multimedia handling capabilities. The browsing entity attributes of the mobile device 112 includes at least one of script execution capabilities and multimedia handling capabilities.

In this embodiment of the present invention, the process step includes parsing the acquired web content into separate one or more component parts. The one or more component parts are stored individually for the content server 108.

In this embodiment of the present invention, customizing the separated one or more component parts of the web content based on the determined display capability and the customization parameters further includes determining a level of rendering required for presentation of web content on the mobile device 112. The level of rendering required for presentation of web content on the mobile device 112 is based on the determined display capability of the mobile device 112 and the customization parameters. At step 414, the flow chart 400 terminates,

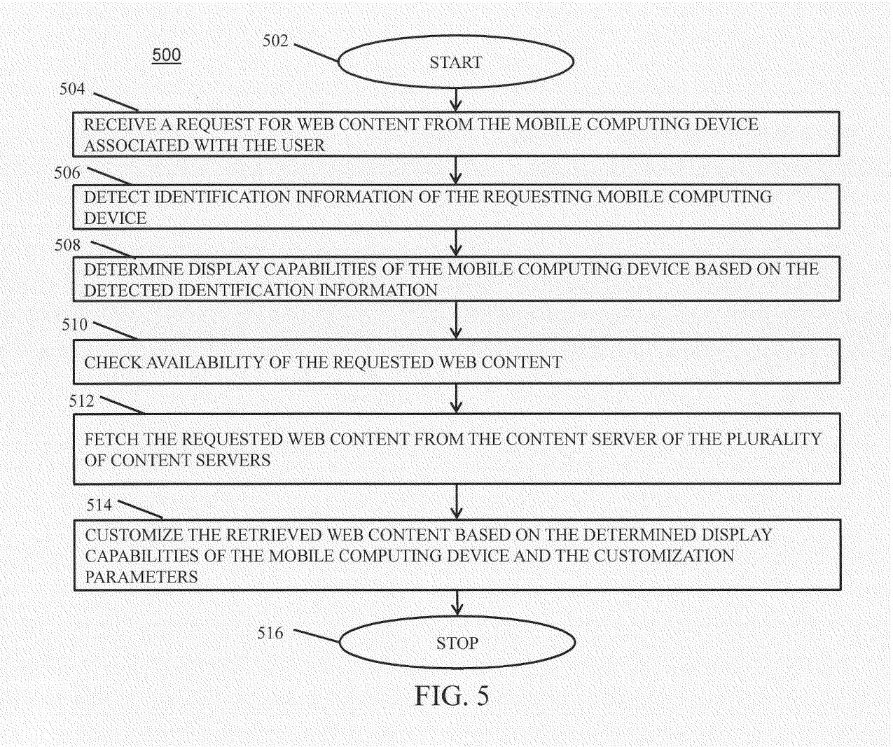

FIG. 5 illustrates a flow chart 500 for rendering web content on the mobile computing device 112 associated with the user 114 over the network 102, in accordance with another embodiment of the present invention. It may be noted that to explain the flow chart 500, references will be made to the system elements of the description of FIG. 1. FIG. 2 and FIG. 3. In addition, those skilled in the art would appreciate that the flow chart 500 may have more or less number of steps which is in the scope of the present invention.

At step 502, the flow chart 500 initiates. At step 504, the content customization platform 106 receives a request for web content from the mobile device 112 associated with the user 114. At step 506, the content customization platform 106 detects identification information of the requesting mobile computing device 112. At step 508, the content customization platform. 106 determines display capabilities of the mobile device 112 based on the detected identification information. At step 510, the content customization platform 106 checks availability of the requested we content. At step 512, the content customization platform 106 fetches the requested web content from the content server 108. At step 514, the content customization platform 106 customizes the retrieved web content based on the determined display capabilities of the mobile device 112 and the customization parameters. Accordingly, the customized web content is rendered on the mobile device 112. In this embodiment of the present invention, the display capability includes at least one of form factor of the mobile device 112, characteristics of the mobile device 112, features of the mobile device 112, attributes of the mobile device 112, browsing entity attributes of the mobile device 112 and limitations of the mobile device 112. The form factor of the mobile device 112 includes at least one of physical dimensions of display of the mobile device 112. The characteristics of the mobile device 112 include at least one of script execution capabilities and multimedia handling capabilities. The browsing entity attributes of the mobile device 112 includes at least one of script execution capabilities and multimedia handling capabilities.

In this embodiment of the present invention, the process step includes parsing the acquired web content into separate one or more component parts. The one or more component parts are stored individually for the content server 108.

In this embodiment of the present invention, customizing the separated one or more component parts of the web content based on the determined display capability and the customization parameters further includes determining a level of rendering required for presentation of web content on the mobile device 112. The level of rendering required for presentation of web content on the mobile device 112 is based on the determined display capability of the mobile device 112 and the customization parameters. At step 514, the flow chart 500 terminates.

The method and system disclosed above handle different mobile devices using a single codebase without having to write and maintain multiple versions of the front end code. Further, the method and system disclosed above allows the decisions regarding the customization of the web content to the frontend developer rather than the content server code.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope 01 the claims if they have structural elements that do not differ from the literal language of the claims, or if they include equivalent structural elements with insubstantial differences from the literal language of the claims.

What is claimed is:

1. A method for rendering web content on a mobile computing device associated with a user over a network, said method comprising:
receiving a request for web content from said mobile computing device associated with said user;
detecting identification information of said requesting mobile computing device;
determining display capabilities of said mobile computing device based on said detected identification information;
retrieving, said requested web content and a plurality of customization parameters from a content server of a plurality of content severs, wherein said server hosts said requested web content; and
customizing said retrieved web content based on said determined display capabilities of said mobile computing device and said customization parameters, wherein said customized web content is rendered :on said mobile computing device.

2. The method as recited in claim 1, further comprising:
checking availability of said requested web content; and
fetching said requested web content from said content server of said plurality of content servers.

3. The method as recited in claim 1, wherein said display capability comprises at least one of form factor of said mobile computing device, characteristics of said mobile computing device, features of said mobile computing device, attributes of said mobile computing device, browsing entity attributes of said mobile computing device and limitations of said mobile computing device.

4. The method as recited in claim 3, wherein said form factor of said mobile computing device comprises at least one of physical dimensions of display of said mobile computing device.

5. The method as recited in claim 4, wherein said characteristics of said mobile computing device comprises at least one of script execution capabilities and multimedia handling capabilities.

6. The method as recited in claim 4, wherein said browsing entity attributes of said mobile computing device comprises at least one of script execution capabilities and multimedia handling capabilities.

7. The method as recited in claim 1, further comprising parsing said acquired web content into separate one or more component parts.

8. The method as recited in claim 7, wherein said one or more component parts is stored individually for said content server of said plurality of content servers.

9. The method as recited in claim 1, wherein customizing said separated one or more component pads of said web content based on said determined display capability and said customization parameters further comprises determining a level of rendering required for presentation of web content on said mobile computing device.

10. The method as recited in claim 9, wherein said level of rendering required for presentation of web content on said mobile computing device is based on said determined display capability of said mobile computing device and said customization parameters.

11. A method for rendering web content on a mobile computing device associated- with a user over a network, said method comprising:
receiving a request for web content from said mobile computing device associated with said user;
detecting identification information of said requesting mobile computing device;
determining display capabilities of said mobile computing device based on said detected identification information;
retrieving said requested web content and a plurality of customization parameters from a content server of a plurality of content severs, wherein said retrieving comprises:
checking availability or said requested web content; and
fetching said requested web content from said content server of said plurality of content servers; and
customizing said retrieved web content based on said determined display capabilities of said mobile computing device and said customization parameters, wherein said customized web content is rendered on said mobile computing device.

12. The method as recited in claim 11, wherein said display capability comprises at least one of form factor of said mobile computing device, characteristics of said mobile computing device, features of said mobile computing device attributes of said mobile computing device, browsing entity attributes of said mobile computing device and limitations of said mobile computing device.

13. The method as recited in claim 12, wherein said form factor of said mobile computing device comprises at least one of physical dimensions of display of said mobile computing device.

14. The method as recited in claim 12, wherein said characteristics of said mobile computing device comprises at least one of script execution capabilities and multimedia handling capabilities.

15. The method as recited in claim 12, wherein said browsing entity attributes of said mobile computing device comprises at least one of script execution capabilities and multimedia handling capabilities.

16. The method as recited in claim 11, further comprising, parsing said acquired web content into separate one or more component parts based on said received request of said mobile computing device.

17. The method as recited in claim 16, wherein said one or more component parts is stored individually for said content server of said plurality of content servers.

18. The method as recited in claim 11, wherein customizing said separated one or more component parts of said web content based on said determined display capability and said customization parameters further comprises determining a level of rendering required for presentation of web content on said mobile computing device.

19. The method as recited in claim 18, wherein said level of rendering required for presentation of web content on said mobile computing device is based on said determined display capability of said mobile computing device and said customization parameters.

20. A computer system for rendering web content on a mobile computing device associated with a use over a network, said computer system comprising:
one or more processors; and
a non-transitory memory containing instructions that, when executed by said one or more processors, causes said one or more processors to perform a set of steps comprising;
receiving, by a request processing module of a content customization platform of said computer system, a request for web content from said mobile computing device associated with said user;
detecting, by a device detection application of said content customization platform of said computer system, an identification information of said requesting mobile computing device;
determining, by said device detection application of said content customization platform of said computer system display capabilities of said mobile computing device based on said detected identification information;
retrieving, by a data acquisition module of said content customization platform of said computer system, said requested web content and a plurality of customization parameters from a content server of a plurality of content severs, wherein said server hosts said requested web content; and
customizing said retrieved, web content based on said determined display capabilities of said mobile computing device and said customization parameters; wherein said customized web content is rendered on said mobile computing device.
